(19) United States
(12) Patent Application Publication
(10) Pub. No.: US 2013/0125156 A1
(43) Pub. Date: May 16, 2013

(54) INTERACTIVE ADVERTISEMENT

(71) Applicant: Palak Shah, San Diego, CA (US)

(72) Inventor: Palak Shah, San Diego, CA (US)

(73) Assignees: SONY NETWORK ENTERTAINMENT INTERNATIONAL LLC., Los Angeles, CA (US); SONY CORPORATION, Tokyo (JP)

(21) Appl. No.: 13/432,674

(22) Filed: Mar. 28, 2012

Related U.S. Application Data
(60) Provisional application No. 61/558,662, filed on Nov. 11, 2011.

(51) Int. Cl. H04N 21/43

(52) U.S. Cl. 725/14

(57) ABSTRACT

Interactive advertisement by capturing images from the content, including: enabling an end user device to capture an image on a screen when a user viewing content on the end user device notices product or service which interests the user; receiving and processing the captured image by generating tags of the captured image and category information of the tags; sending the category information to the end user device to display it to the user, wherein the user selects a category from the category information; receiving and processing the selected category and corresponding tags; and obtaining and sending detailed information related to the processed tags to the end user device. Keywords include interactive advertisement.

### CROSS-REFERENCE TO RELATED APPLICATIONS

This application claims the benefit of priority under 35 U.S.C. §119(e) of co-pending U.S. Provisional Patent Application No. 61/558,662, filed Nov. 11, 2011, entitled “Interactive Advertisement and Personal Todo Service.” The disclosure of the above-referenced application is incorporated herein by reference.

### BACKGROUND

1. Field of the Invention

The present invention relates to advertisement, and more specifically, to capturing interactive advertisement.

2. Background

Interactive television is an interactive audio/video delivery medium which provides broadcast audiovisual content to a number of subscribers. Interactive television provides broadcast video and audio to users and also provides a return path for the user to interact with the content, for example, to make selections or order desired products. Unlike the Internet, interactive television is primarily a broadcast medium which generally requires that the same audiovisual content be delivered to each user or subscriber.

As with any conventional television broadcast, commercials are regularly shown during regular interactive television programming. Commercials often contain written information for advertising purposes such as a contact phone number, e-mail address, or web address that a subscriber may wish to record and utilize at a later time. Unfortunately for advertisers, a subscriber often does not have a writing utensil and paper conveniently located nearby while watching the television, or even when the subscriber has written the information down, the subscriber does not act on it further because the information is lost or the subscriber has lost interest because the commercial is not fresh in the subscriber's mind.

### SUMMARY

The present invention provides for capturing interactive advertisement.

In one implementation, a method of capturing interactive advertisement is disclosed. The method includes: enabling an end user device to capture an image on a screen when a user viewing content on the end user device notices product or service which interests the user; receiving and processing the captured image by generating tags of the captured image and category information of the tags; sending the category information to the end user device to display it to the user, wherein the user selects a category from the category information; receiving and processing the selected category and corresponding tags; and obtaining and sending detailed information related to the processed tags to the end user device.

In another implementation, a non-transitory storage medium storing a computer program to capture interactive advertisement is disclosed. The computer program includes executable instructions that cause a computer to: enable an end user device to capture an image on a screen when a user viewing content on the end user device notices product or service which interests the user; receive and process the captured image by generating tags of the captured image and category information of the tags; send the category information to the end user device to display it to the user, wherein the user selects a category from the category information; receive and process the selected category and corresponding tags; and obtain and send detailed information related to the processed tags to the end user device.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a sequence diagram for capturing interactive advertisement in accordance with one implementation of the present invention.

FIG. 2 is a functional block diagram of a system for capturing interactive advertisement in accordance with one implementation of the present invention.

FIG. 3A illustrates a representation of a computer system and a user.

FIG. 3B is a functional block diagram illustrating the computer system hosting an interactive advertiser.

### DETAILED DESCRIPTION

Certain implementations as disclosed herein describe apparatus, methods, and systems for capturing interactive advertisement. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

In one implementation, when a user viewing content on an end user device such as Internet Protocol television (IPTV) shows some interest in an advertisement, the advertiser may want to capture that interest to make the sales chances higher. If there is no way to capture this interest it might get lost. In this implementation, that interest is used to provide a good shopping experience to the user and an excellent sales opportunity for the advertiser. It also benefits the service provider (e.g., broadcaster or IPTV service provider) or the video device provider (e.g., television manufacturer) by improving the value of advertising presented through their service or device.

In particular, advertisements are made more interactive by capturing screen image and analyzing the captured image to identify the product, service, merchant, or advertiser. For example, while watching the IPTV, the user causes the IPTV to capture the image on the screen when the user notices product and/or service which interests the user. A Todo service can also be built and maintained on the IPTV to remind the user about the advertisement. The IPTV then sends the captured image to a portal server which forwards the image to an image processing server to process the captured image. The portal server may perform the image recognition internally. Once the captured image has been processed, the portal server sends the result of the image recognition information to the IPTV to display it on the screen. The processed result can be viewed on the graphics plane of the IPTV or can be presented as a personal “to do” service as a part of menu options. The Todo service can store previously captured advertisements. Some IPTVs can display the Todo service and actual content at the same time on the screen, such as by using Picture in Picture, split screen, or overlays. The end user device acts as a client with respect to the interactive advertisement portal server.

In one example, the captured screen image includes an image of the logo or symbol of a store. The IPTV sends the image through a network to a server. The IPTV can also send information about the IPTV (e.g., location). The server analyzes the image and recognizes the store's symbol to determine which store is in the advertisement. The server also assesses the received IPTV information, such as geographic location, to customize the response. The server retrieves information about the identified store and builds a response providing information about available deals, sales items, etc. The server returns the response to the IPTV, and the IPTV presents a reply or stores the response for a future access. In another example, the user captures a fashion merchandise advertisement and sends the advertisement to the server. The server returns a catalog for the identified advertiser. The user can view the catalog for clothes through the IPTV's Todo service.

In other examples, the server can return other information. In one implementation, the image recognition technique of the server can identify and return phone numbers from an advertisement. In another implementation, the server can also tag text information in the image so that a user can search a network (e.g., using a network search engine or service) to get more details/reviews of the advertised product.

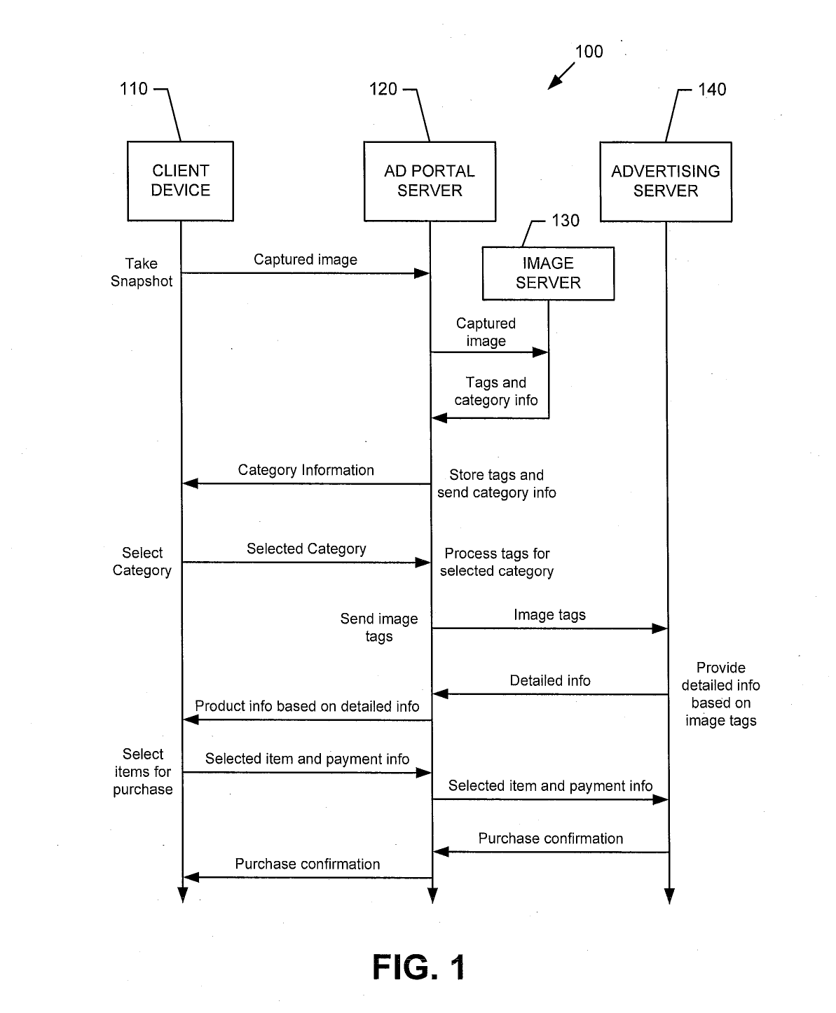

FIG. 1 is a sequence diagram 100 for capturing interactive advertisement in accordance with one implementation of the present invention. In the illustrated implementation of FIG. 1, when a user viewing content on an end user device 110 such as IPTV notices product and/or service which interests the user, the user causes the end user device 110 to take a snapshot of the image on the screen. The end user device 110 then sends the captured image to a portal server 120 which forwards the image to an image processing server 130 to process the captured image. In an alternative, the portal server 120 may perform the image processing internally. The image processing server 130 processes the captured image by generating all tags of the captured image, and may also generate category information of the tags.

Once the captured image has been processed, the portal server 120 sends the result of the image processing including category information of the captured image to the end user device 110 to display it on the screen. The processed result can be viewed on the graphics plane of the end user device 110 or can be presented as a personal “to do” service as a part of menu options. The Todo service can store previously captured advertisements. Some end user devices can display the Todo service and actual content at the same time on the screen, such as by using Picture in Picture, split screen, or overlays.

When the category information is displayed on the screen of the end user device 110, the user selects a category from the category information to receive product information, and sends the selected category to the portal server 120. The portal server 120 then processes the tags for the selected category, and sends the processed tags to the advertising server 140. In one implementation, the processed tags identify the logo of a store. In another implementation, the processed tags identify a type of product such as fashion merchandise. In yet another implementation, the portal server 120 can also send information about the end user device (e.g., location of the end user device) to help the advertising server 140 to generate product information that is tailored to the user of the end user device 110. Thus, based on the tags sent from the portal server 120, the advertising server 140 generates and sends detailed product or service information to the portal server 120.

The detailed product or service information can then be passed onto the end user device 110. In one implementation, the detailed product or service information includes available deals, sales items, etc., of the store. In an alternative, the portal server 120 can add more information to the detailed product or service information before sending it to the end user device 110 and displaying the detailed production or service information on the screen of the end user device 110. The user reviews the detailed product or service information and selects items for purchase. The end user device 110 sends the selected items and payment information to the portal server 120, which passes the received information onto advertising server 140. When the advertising server 140 verifies the accuracy of the selected items and the payment information, it sends the purchase confirmation to the end user device 110 through the portal server 120.

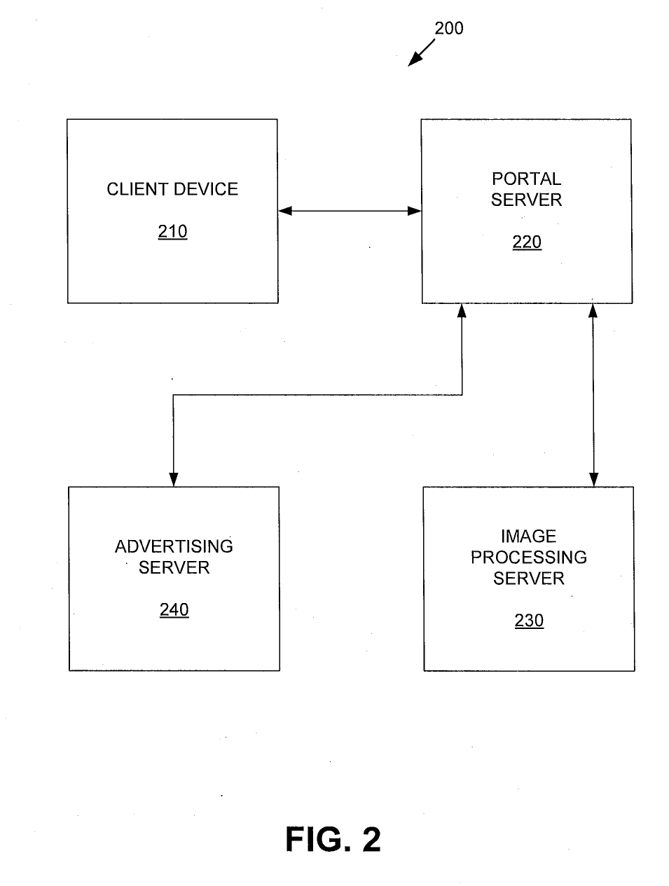

FIG. 2 is a functional block diagram of a system 200 for capturing interactive advertisement in accordance with one implementation of the present invention. In the illustrated implementation of FIG. 2, an end user device 210 is used to shop or browse online for products and/or services. The end user device 210 captures a snapshot of the image on the screen of the end user device 210 when the user using the end user device to shop or browse online finds something the user likes. The end user device 210 then sends the captured image to a portal server 220 which forwards the image to an image processing server 230 to process the captured image. In an alternative, the portal server 220 may perform the image processing internally. The image processing server 230 processes the captured image by generating all tags of the captured image, and may also generate category information of the tags.

Once the captured image has been processed, the portal server 220 sends the result of the image processing including category information of the captured image to the end user device 210 to display it on the screen. The processed result can be viewed on the graphics plane of the end user device 210 or can be presented as a personal to do” service as a part of menu options. The Todo service can store previously captured advertisements. Some end user devices can display the Todo service and actual content at the same time on the screen, such as by using Picture in Picture, split screen, or overlays.

The end user device 210 enables the user to select a category from the category information, and sends the selected category to the portal server 220. The portal server 220 then processes the tags for the selected category, and sends the processed tags to the advertising server 240. In one implementation, the processed tags identify the logo of a store. In another implementation, the processed tags identify a type of product such as fashion merchandise. In yet another implementation, the portal server 220 can also send information about the end user device (e.g., location of the end user device) to help the advertising server 240 to generate product information that is tailored to the user of the end user device 210. Thus, based on the tags sent from the portal server 220, the advertising server 240 generates and sends detailed product or service information to the portal server 220.

The portal server 220 then passes the detailed product or service information onto the end user device 210. In one implementation, the detailed product or service information includes available deals, sales items, etc., the store. In an alternative, the portal server 220 can add more information to the detailed product or service information before sending it to the end user device 210 and displaying the detailed production or service information on the screen of the end user device 210. The user reviews the detailed product or service information and selects items for purchase. The end user device 210 sends the selected items and payment information to the portal server 220, which passes the received information onto advertising server 240. When the advertising server 240 verifies the accuracy of the selected items and the payment information, it sends the purchase confirmation to the end user device 210 through the portal server 220.

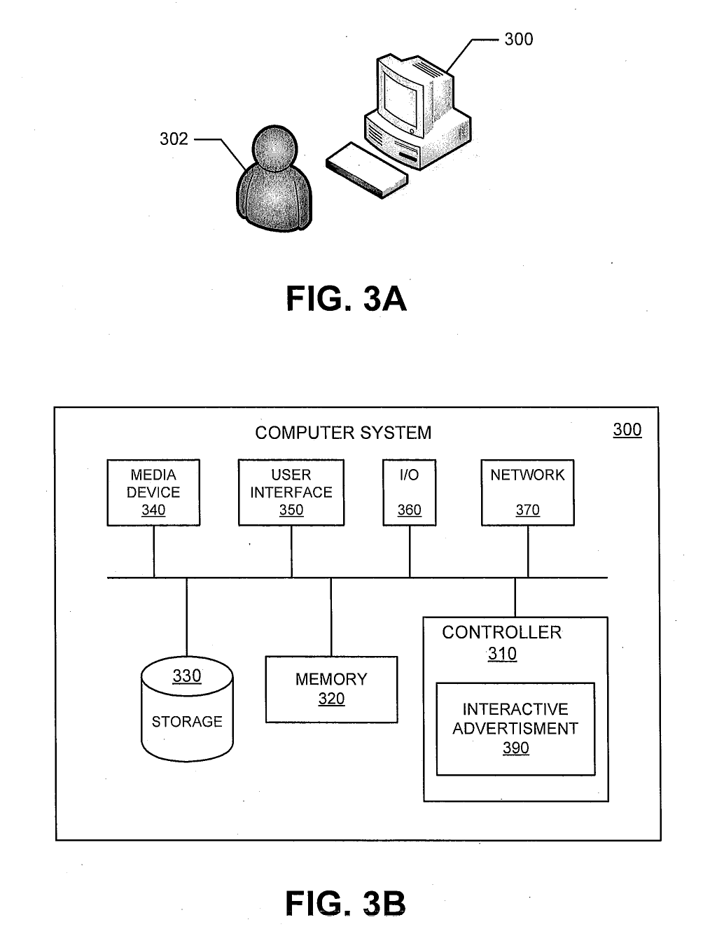

FIG. 3A illustrates a representation of a computer system 300 and a user 302. In one implementation, the computer system can be configured as a portal server (e.g., reference 120 in FIG. 1) configured to provide interactive advertisement capture.

FIG. 3B is a functional block diagram illustrating the computer system 300 hosting an interactive advertiser 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the interactive advertiser 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the interactive advertiser 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user 302 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, although the specification focuses on capturing interactive advertisement, other items of content on the television such as snippet of a movie can be captured for processing. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of capturing interactive advertisement, the method comprising:
enabling an end user device to capture an image on a screen when a user viewing content on the end user device notices product or service which interests the user;
receiving and processing the captured image by generating tags of the captured image and category information of the tags;
sending the category information to the end user device to display it to the user,
wherein the user selects a category from the category information;
receiving and processing the selected category and corresponding tags; and
obtaining and sending detailed information related to the processed tags to the end user device.

2. The method of claim 1, wherein the end user device is an Internet Protocol television (IPTV) device.

3. The method of claim 1, further comprising
displaying the category information on a display of the end user device.

4. The method of claim 3, wherein displaying the category information on a display of the end user device comprises
displaying the category information on a graphics plane of the end user device.

5. The method of claim 3, wherein displaying the category information on a display of the end user device comprises
displaying the category information as a personal Todo service as a part of menu options.

6. The method of claim 5, further comprising
storing previously captured advertisements by the personal Todo service.

7. The method of claim 1, wherein the processed tags identify a logo of a store.

8. The method of claim 1, wherein the processed tags identify a type of product.

9. The method of claim 1, wherein obtaining detailed information related to the processed tags comprises
obtaining location of the end user device and using the location to tailor the detailed information for the user.

10. The method of claim 1, wherein the detailed information related to the processed tags comprises
detailed product or service information including at least one of available deals and sales items of a store.

11. The method of claim 1, further comprising
enabling the user to review the detailed information related to the processed tags,
wherein the user selects items from the detailed information for purchase.

12. The method of claim 11, further comprising
receiving the selected items and payment information from the end user device.

13. A non-transitory storage medium storing a computer program to capture interactive advertisement, the computer program comprising executable instructions that cause a computer to:
enable an end user device to capture an image on a screen when a user viewing content on the end user device notices product or service which interests the user;
receive and process the captured image by generating tags of the captured image and category information of the tags;
send the category information to the end user device to display it to the user,
wherein the user selects a category from the category information;
receive and process the selected category and corresponding tags; and
obtain and send detailed information related to the processed tags to the end user device.

14. The non-transitory storage medium of claim 13, wherein the processed tags identify a logo of a store.

15. The non-transitory storage medium of claim 13, wherein the processed tags identify a type of product.

16. The non-transitory storage medium of claim 13, wherein executable instructions that cause a computer to obtain detailed information related to the processed tags comprises executable instructions that cause a computer to
obtain location of the end user device and using the location to tailor the detailed information for the user.

17. The non-transitory storage medium of claim 13, wherein the detailed information related to the processed tags comprises
detailed product or service information including at least one of available deals and sales items of a store.

18. The non-transitory storage medium of claim 13, further comprising executable instructions that cause a computer to
enable the user to review the detailed information related to the processed tags,
wherein the user selects items from the detailed information for purchase.

19. The non-transitory storage medium of claim 18, further comprising executable instructions that cause a computer to
receive the selected items and payment information from the end user device.
